(19) United States
(12) Patent Application Publication
(10) Pub. No.: US 2025/0130064 A1
(43) Pub. Date: Apr. 24, 2025

(54) Method and Driver Assistance System for Assisting a Driver in Driving Along a Recorded Trajectory

(71) Applicant: Bayerische Motoren Werke Aktiengesellschaft, Muenchen (DE)

(72) Inventors: Andreas BOESL, Muenchen (DE); Michael STROEBEL, Groebenzell (DE)

(21) Appl. No.: 18/689,127

(22) PCT Filed: Aug. 24, 2022
(86) PCT No.: PCT/EP2022/073609

§ 371 Date: Mar. 5, 2024

(30) Foreign Application Priority Data
Sep. 13, 2021 (DE) 10 2021 123 585.5

(51) Int. Cl. G01C 21/00

(52) U.S. Cl. CPC G01C 21/3826; G01C 21/3837

(57) ABSTRACT

A driver assistance system is designed to assist a driver of a motor vehicle during a second trip along a trajectory that was recorded during a first trip. The driver assistance system is designed to determine altitude change information regarding an altitude change of the trajectory recorded during the first trip. The driver assistance system is also designed to determine a display trajectory for the second trip using the altitude change information and to cause the display trajectory to be displayed on a display unit.

### BACKGROUND AND SUMMARY

The invention relates to a method and a corresponding driver assistance system, which are designed to assist the driver of a vehicle during a renewed journey (in particular during a return journey) along a recorded trajectory.

A vehicle may comprise an assistance system designed to record and store a traveled path, in particular a driving trajectory, of the vehicle during an outward journey. For example, trajectory data in relation to the driving trajectory driven by the vehicle when parking in a parking bay and/or when maneuvering can be recorded and stored.

The stored trajectory data in relation to the driving trajectory on the outward journey can be used to assist the user, especially the driver, of the vehicle during a corresponding return journey. In particular, a driving path can be shown to the user of the vehicle on an electronic visual display of the vehicle during the return journey, with the driving path depending on the trajectory data. In this case, the driving path may correspond to the driving trajectory driven on the outbound journey.

The driving path displayed on the electronic visual display of the vehicle during a return journey may be confusing for the user of the vehicle. In particular, the situation may arise where the driving path overlaid on a camera image of the surround of the vehicle is not located on the roadway displayed in the camera image.

The present document considers the technical problem of increasing the quality of a driver assistance system for assisting the driver of a vehicle during a journey along a recorded trajectory, in particular in relation to the quality of the driving path displayed during the journey.

The problem is solved by each of the independent claims. Advantageous embodiments are described inter alia in the dependent claims. It is pointed out that additional features of a patent claim dependent on an independent patent claim are able, without the features of the independent patent claim or only in combination with a subset of the features of the independent patent claim, to form a separate invention, independent of the combination of all of the features of the independent patent claim, that can be made the subject matter of an independent claim, of a divisional application or of a subsequent application. This applies in the same manner to technical teachings described in the description that are able to form an invention independent of the features of the independent patent claims.

According to one aspect, a driver assistance system is described, which is designed to assist a driver of a (motor) vehicle during a second journey along a trajectory recorded within the scope of a (preceding) first journey. The first journey may comprise an outward journey from a first point (e.g., from a start point) to a second point (e.g., to an end point). The second journey may comprise a corresponding return journey from the second point to the first point. Hence, the driver assistance system can be designed to assist the driver during a return journey.

Alternatively, the second journey may comprise a repetition of the first journey (in the same direction of travel). Thus, the first journey may comprise a journey from the first point to the second point, and the second journey may comprise a renewed journey from the first point to the second point.

Optionally, a journey may be composed of a plurality of stages. In that case, the journey can be carried out over one or more intermediate points or over one or more further points. In this context, the direction of travel of the vehicle may be different in distinct stages of a multi-stage journey. In particular, the direction of travel may in each case change between two directly successive stages (between forward and backward or between backward and forward). The aspects described in this document are also applicable to multi-stage journeys. In so doing, the aspects described may be applied in particular to each individual stage of the multi-stage journey.

The driver assistance system may be configured to cause an automated longitudinal and/or transverse guidance of the vehicle (e.g., within the scope of the first journey and/or within the scope of the second journey). In this context, an automated transverse guidance may be brought about within the scope of the second journey in particular. In that case, the longitudinal guidance may optionally be brought about manually by the driver. In an alternative example, the second journey (in relation to the longitudinal and transverse guidance) may be brought about manually (optionally entirely manually) by the driver.

Trajectory data in relation to the trajectory of the first journey may have been ascertained and recorded within the scope of the first journey. The trajectory data may indicate positions (e.g., within the xy-plane of a Cartesian coordinate system) of a multiplicity of waypoints on the trajectory recorded during the first journey. The trajectory data may have been ascertained on the basis of sensor data from one or more vehicle sensors and/or on the basis of map data in relation to the roadway traveled by the vehicle.

The driver assistance system is configured to ascertain elevational change information in relation to the one or more (positive or negative) elevational changes of the trajectory recorded within the scope of the first journey. In particular, the elevational change information may comprise gradient data in relation to the (positive or negative) gradient of the trajectory recorded during the first journey. The elevational change information may in this case indicate the absolute and/or relative elevation of the multiplicity of waypoints with respect to one another. In particular, the elevational change information may indicate the elevational change between the multiplicity of waypoints, in particular between individual waypoints (optionally directly successive waypoints). In this case, the elevation of the individual waypoints can be indicated along an elevation axis. In this case, the elevation axis may correspond to the vertical axis of the vehicle when the vehicle is aligned horizontally. In an alternative or in addition, the elevation axis may correspond to the z-axis of the Cartesian coordinate system.

The elevational change information may have been ascertained on the basis of the sensor data from one or more vehicle sensors (e.g., on the basis of the sensor data from an inertial measurement unit) and/or on the basis of map data in relation to the roadway traveled by the vehicle. The elevational change information may have been ascertained and/or acquired during the first journey. Further, the elevational change information may have been stored (optionally together with the trajectory data) in a memory unit of the vehicle. The driver assistance system may be designed to read the elevational change information and/or the trajectory data from the memory unit for the purpose of providing a driver assistance during the (subsequent) second journey. Ascertainment of the elevational change information and/or the trajectory data may therefore comprise the readout of the elevational change information and/or the trajectory data from a memory unit.

For example, the respective inclination of the vehicle (in relation to the horizontal) may be ascertained for the multiplicity of waypoints within the scope of the first journey. The inclination of the vehicle may be ascertained on the basis of a vehicle sensor, in particular on the basis of an inertial measurement unit. The inclination of the vehicle at the individual waypoints can be stored as elevational change information. The inclination of the vehicle at a specific waypoint can be used to deduce the elevational change, in particular the gradient, present from the specific waypoint to the subsequent waypoint.

The driver assistance system is further configured to take account of the elevational change information (optionally in addition to the trajectory data) for the purpose of providing a driver assistance during the second journey. In particular, the driver assistance system can be configured to ascertain a display trajectory (e.g., in the form of a driving path) for the second journey taking into account the elevational change information. In this case, the display trajectory may indicate the course of the trajectory to be traveled by the vehicle. Further, the display trajectory may correspond to the trajectory recorded during the first journey.

The driver assistance system may be configured to cause the display trajectory to be displayed on a display unit (in particular on an electronic visual display and/or on a head-up display). In this case, the display unit can be a display unit of the vehicle and/or a display unit of an electronic user device of the driver of the vehicle (for instance, of a smartphone).

The quality of the driver assistance can be increased by taking account of the elevational change information, in particular the gradient data, within the scope of the driver assistance for a (renewed) second journey on the basis of an already recorded trajectory. In particular, the accuracy of the ascertained and displayed display trajectory can be increased for the second journey.

During the second journey the driver assistance system may be configured to ascertain (typically repeatedly ascertain) image data in relation to the surround of the vehicle located in front of the vehicle in the direction of travel using at least one camera (and optionally a plurality of cameras) of the vehicle. In this case, the one or more cameras may be arranged at the front and/or rear end of the vehicle. Moreover, on the basis of the image data, the driver assistance system may be configured to cause a pictorial representation showing the display trajectory overlaid on the surround of the vehicle to be displayed or output on the display unit. By taking account of the elevational change information when ascertaining the display trajectory it is possible to bring about increased consistency of the displayed display trajectory with the shown image data from the surround of the vehicle. This can further increase the quality of the driver assistance.

The driver assistance system may be configured to repeatedly ascertain the respective actual position of the vehicle, in particular the respective actual position of the camera of the vehicle, during the second journey. Then, the display trajectory can be updated in a manner dependent on the respective actual position (and while taking account of the elevational change information). Further, the respective updated display trajectory may be caused to be displayed on the display unit of the vehicle (in a manner overlaid on the respective detected surround of the vehicle). Consequently, the display trajectory can be repeatedly adapted in a manner dependent on the respective actual position of the vehicle (and hence dependent on the respective shown surround of the vehicle). This can further increase the quality of the driver assistance.

The driver assistance system may be configured to ascertain a projection point of the camera at the respective actual position of the vehicle. In that case, the multiplicity of waypoints on the trajectory recorded during the first journey can be projected onto a projection plane in a manner dependent on the projection point and dependent on the elevational change information, in particular dependent on the respective (relative) elevation of the individual waypoints, in order to determine the display trajectory. In so doing, the elevation axis may be arranged within the projection plane.

By taking account of the (relative) elevation of the individual waypoints on the trajectory recorded within the scope of the first journey it is possible to ascertain the display trajectory in particularly precise fashion. This can further increase the quality of the driver assistance.

According to a further aspect, a (road-based) motor vehicle (in particular, an automobile or a truck or a bus or a motorcycle) comprising the apparatus described in this document is described.

According to a further aspect, a method is described for providing a driver assistance during a (subsequent) second journey along a trajectory recorded within the scope of a (preceding) first journey. The method comprises the ascertainment of elevational change information in relation to the elevational change, in particular the gradient, of the trajectory recorded within the scope of the first journey. Moreover, the method comprises the consideration of the elevational change information for the purpose of providing a driver assistance during the second journey. In particular, the method may comprise the ascertainment of a display trajectory for the second journey taking into account the elevational change information. Moreover, the method may comprise the display of the display trajectory on a display unit (of the vehicle or of an electronic user device).

According to a further aspect, a software (SW) program is described. The SW program may be configured to be executed on a processor (e.g., on a controller of a vehicle) and to thereby carry out the method described in this document.

According to a further aspect, a storage medium is described. The storage medium may comprise a SW program configured to be executed on a processor and thereby to carry out the method described in this document.

It should be noted that the methods, apparatuses and systems described in this document may be used either alone or in combination with other methods, apparatuses and systems described in this document. In addition, any aspects of the methods, apparatuses and systems described in this document may be combined with one another in a wide variety of ways. In particular, the features of the claims may be combined with one another in a wide variety of ways. Furthermore, features between parentheses should be understood to be optional features.

The invention is described in more detail below on the basis of exemplary embodiments.

### BRIEF DESCRIPTION OF THE DRAWINGS

FIG. 1 shows exemplary components of a vehicle;

FIG. 2a shows an exemplary recorded outward journey trajectory;

FIG. 2b shows an exemplary pictorial representation of a return journey trajectory;

FIG. 3a shows an exemplary outward journey trajectory with an elevational change, in particular a gradient;

FIG. 3b shows an exemplary pictorial representation of the return journey trajectory without taking account of the elevational change, in particular the gradient;

FIG. 4a shows an exemplary projection of waypoints on the outward journey trajectory without taking account of the elevational change, in particular the gradient;

FIG. 4b shows an exemplary projection of waypoints on the outward journey trajectory which takes into account the elevational change, in particular the gradient; and

FIG. 5 is a flowchart of an exemplary method for assisting a vehicle user with a journey along a recorded trajectory.

### DETAILED DESCRIPTION OF THE DRAWINGS

As set forth at the outset, the present document considers the increase in quality of a driver assistant, in particular in relation to the display trajectory displayed during a journey. Hereinbelow, a return journey is discussed on the basis of an outward journey trajectory recorded during an outward journey. It is pointed out that in general the described aspects are applicable to a second journey carried out on the basis of a trajectory recorded during a first journey.

FIG. 1 shows an exemplary vehicle 100 having one or more surround sensors 102 (e.g., a camera, a radar sensor, a lidar sensor, etc.) and one or more vehicle sensors 103 (e.g., a steering sensor, a speed sensor, an inertial measurement unit (IMU), etc.). During an outward journey (e.g., during maneuvering) and on the basis of the sensor data from the one or more surround sensors 102 and/or on the basis of the one or more vehicle sensors 103, a (control) apparatus 101 of the vehicle 100 may be configured to acquire trajectory data relating to the outward journey trajectory traveled during the outward journey and to store the trajectory data in a memory unit (not depicted here) of the vehicle 100.

The vehicle 100 also comprises a rearward camera 106 which is configured to capture image data relating to the surround of the vehicle 100 located in front of the vehicle 100 in the direction of travel of the vehicle 100 during a return journey of the vehicle 100. In particular, the surround of the rear end of the vehicle 100 can be captured by the camera 106 during rearward driving of the vehicle 100.

The vehicle 100 may also comprise one or more longitudinal and/or transverse guidance actuators 104, which are designed to bring about at least partly automated longitudinal and/or transverse guidance of the vehicle 100. Exemplary actuators 104 include a drive motor, a steering apparatus and/or a braking apparatus. The (control) apparatus 101 may be configured to control the one or more actuators 104 during a return journey in a manner dependent on the trajectory data relating to the outward journey, in order to assist the driver of the vehicle 100 during the return journey.

Moreover, the vehicle 100 comprises a display unit 105 which may for example be arranged on the instrument panel and/or on the head unit of the vehicle 100. The display unit 105 may comprise an electronic visual display (in particular an LCD, LED or OLED electronic visual display), a projector and/or a head-up display. The apparatus 101 may be configured to cause the image data of the rearward camera 106 to be displayed on the display unit 105 during a return journey. In particular, the surround located in front of the vehicle 100 in the direction of travel may be displayed (in the form of a video) in the process.

The apparatus 101 may further be configured to ascertain a return travel trajectory on the basis of the trajectory data acquired during the corresponding outward journey and to pictorially represent this return travel trajectory on the display unit 105, and in the process overlay this on the image data of the rearward camera 106. In this case, the return journey trajectory (also referred to as display trajectory in this document) may indicate to the user, especially the driver, of the vehicle 100 how the vehicle 100 should be steered during the return journey, in particular in order to return the vehicle 100 along the outward journey trajectory. In this context, the steering of the vehicle 100 during the return journey can be brought about in automated fashion by the vehicle 100 or manually by the driver. If the steering, i.e. the transverse guidance, of the vehicle 100 is brought about in automated fashion by the vehicle 100, then the displayed return journey trajectory may represent assistance to the driver when verifying the automated transverse guidance. If steering is brought about manually by the driver, then the displayed return journey trajectory can be used by the driver as a clue for the steering to be brought about by the driver.

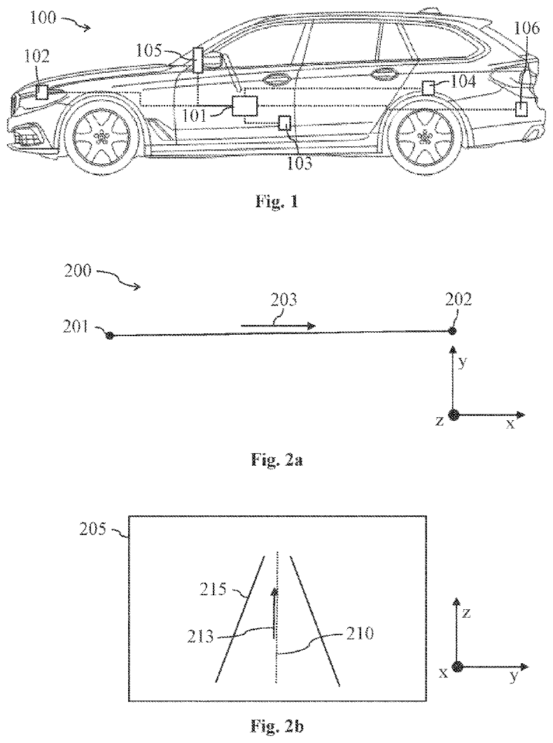

FIG. 2a shows an exemplary outward journey trajectory 200, recorded and stored during an outward journey 203 (in general during a first journey), from a start point 201 to an end point 202. In this case, the outward journey trajectory 200 may include any desired waypoints in the plane spanned by the x-axis and y-axis. Then again, changes in elevation along the z-axis are typically not recorded. In the example depicted in FIG. 2a, the outward journey trajectory 200 only has points along the x-axis for simplified display.

FIG. 2b shows an exemplary pictorial representation 205 which can be output on the display unit 105 of the vehicle 100 during a return journey 213 (in general during a second journey). The pictorial representation 205 may comprise the image data 215 from the rearward camera 106. In the example depicted in FIG. 2b, roadway boundaries of the roadway in the surround of the vehicle 100 are visible in the image data 215.

The image data 215 of the rearward camera 106 may be overlaid with a (representation of the) return journey trajectory 210 (in general with the display trajectory) ascertained on the basis of the trajectory data relating to the outward journey trajectory 200. In particular, a return journey trajectory 210 (e.g., in the form of a driving path) indicating to the user of the vehicle 100 how the vehicle 100 should be longitudinally and/or transversely guided during the return journey 213 (in order to return the vehicle 100 in accordance with the outward journey trajectory 200) may additionally be displayed on the image data 215.

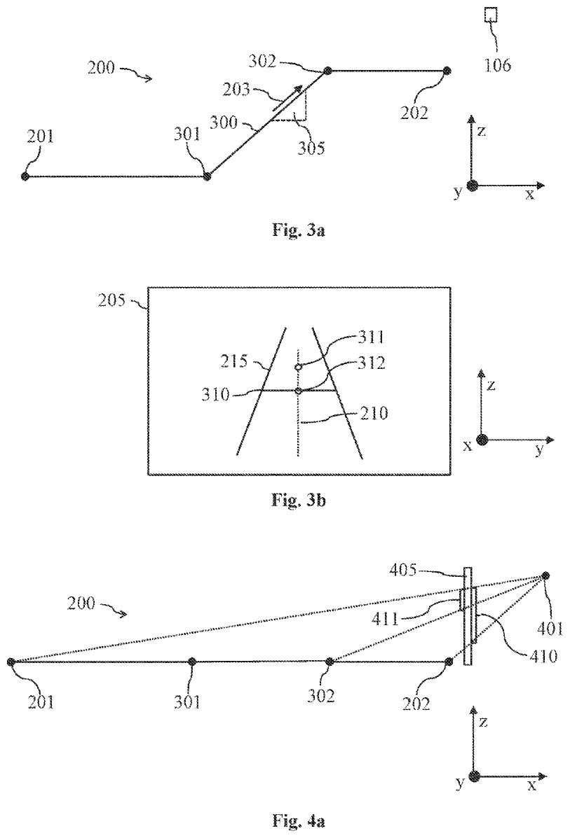

FIG. 3a shows an exemplary outward journey trajectory 200 which comprises a section 300 with an elevation change (along the z-axis or vertical axis). In particular, the outward journey trajectory 200 has a (positive) elevational change, in particular gradient, 305 (along the z-axis) between the points 301, 302. In other words, the roadway traveled by the vehicle 100 during the outward journey 203 has an elevational change, in particular gradient, 305 in the example depicted in FIG. 3a. This elevational change, in particular gradient, 305 affects how the surround of the vehicle 100 is visible on the display unit 105 during the corresponding return journey 213.

FIG. 3a depicts the rearward camera 106 of the vehicle 100 at the start of the return journey 213. It is evident from FIG. 3a that the section 300 (between the points 301 and 302) of the roadway on the outward journey trajectory 200 is visible only in restricted and in particular shortened fashion to the rearward camera 106 on account of the elevational change, in particular gradient, 305.

If the elevational change, in particular gradient, 305 of the outward journey trajectory 200 is not captured during the outward journey 203, then the outward journey trajectory 200 depicted in FIG. 2a is reproduced by the trajectory data of the outward journey trajectory 200 depicted in FIG. 3a. Consequently, no consideration is given to the fact that the outward journey trajectory 200 contains a section 300 with an elevational change, in particular gradient, 305 which is reproduced in shortened fashion in the image data 215 during the return journey 213. This may lead to the return journey trajectory 210 ascertained on the basis of the trajectory data not fitting to the image data 215 of the surround of the vehicle 100 captured and displayed during the return journey 213.

FIG. 3b shows an exemplary pictorial representation 205 for a return journey 213, which corresponds to the situation depicted in FIG. 3a in the case of a corresponding outward journey 203. The section 300 with the elevational change, in particular gradient, 305 can only be seen in shortened fashion in the image data 215 and is depicted by way of example as an edge 310 in FIG. 3b. This shortening of the roadway visible in the image data 215 may lead to a return journey trajectory 210 ascertained without taking account of the elevational change, in particular gradient, 305 not fitting to the image data 215. In particular, the situation may arise that the return journey trajectory 210 depicted in the pictorial representation 205 floats above the roadway visible in the image data 215.

FIG. 3b shows the point 312 on the return journey trajectory 210 which corresponds to the waypoint 302 on the outward journey trajectory 200. Further, FIG. 3b shows the point 311 on the return journey trajectory 210 which corresponds to the waypoint 301 on the outward journey trajectory 200. These two points 311, 312 should be located relatively close together on account of the elevational change, in particular gradient, 305 between the two waypoints 301, 302, but this is not the case in the example illustrated in FIG. 3b. As a consequence, the impression arises in the pictorial representation 205 that the displayed return journey trajectory 210 floats behind the point 312 above the roadway visible in the image data 215.

Accordingly, a negative elevational change, in particular gradient, 305 may give rise to the situation that the return journey trajectory 210 depicted in the pictorial representation 205 penetrates into the roadway visible in the image data 215. As a consequence, this impairs the quality of the driver assistance during the return journey 213.

During an outward journey 203, the (control) apparatus 101 may be configured to ascertain and store elevational change information in relation to an elevational change 305, in particular gradient data in relation to the gradient, of the roadway driven by the vehicle 100 during the outward journey 203. In particular, trajectory data may be ascertained in relation to the outward journey trajectory 200 and may be stored, the trajectory data also comprising the (positive or negative) elevational change, in particular gradient, 305 of the outward journey trajectory 200. The elevational change information, in particular the gradient data, can be ascertained on the basis of the sensor data from one or more vehicle sensors 103 (e.g., an inertial measurement unit, IMU).

The apparatus 101 may further be configured to ascertain the return journey trajectory 210 to be displayed during a corresponding return journey 213 by giving consideration to the elevational change information, in particular the gradient data. This allows the accuracy of the displayed return journey trajectory 210 to be increased. In particular, this can cause the shown return journey trajectory 210 to fit to the captured and displayed image data 215 from the rearward camera 106. This can increase the quality of the return journey assistance.

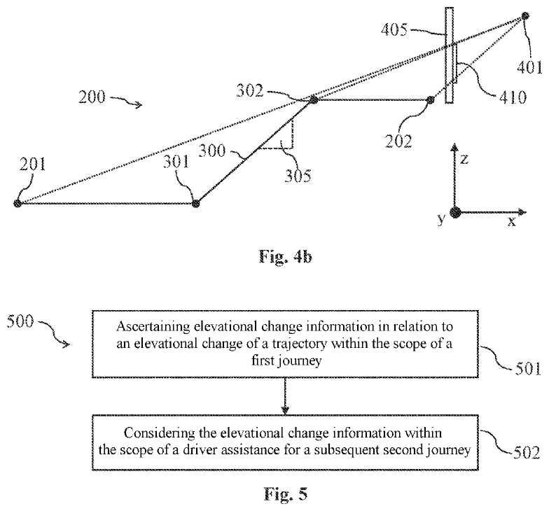

FIGS. 4a and 4b illustrate an exemplary ascertainment of a return journey trajectory 210 without considering the elevational change information (FIG. 4a) and with considering the elevational change information (FIG. 4b), for the outward journey trajectory 200 displayed in FIG. 3a. When ascertaining the return journey trajectory 210 intended to be displayed within the pictorial representation 205 at a specific time or at a specific position during the return journey 213, it is possible to consider the projection point 401 of the rearward camera 106 at the specific time or at the specific position. This can cause the image data 215 captured at the specific time or at the specific position to fit to the ascertained return journey trajectory 210.

The different waypoints 201, 301, 302, 202 on the outward journey trajectory 200 can be projected onto a projection plane 405 while taking account of the projection point 401. The waypoints 201, 301, 302, 202 of the outward journey trajectory 200 projected onto the projection plane 405 yields the trajectory 410 which is projected onto the projection plane 405 and which can be displayed as return journey trajectory 210.

As evident from FIG. 4a, the projected trajectory 410 comprises a relatively long section 411 between the waypoints 201 and 302 of the outward journey trajectory 200 in the case where the elevational change, in particular gradient, 305 of the outward journey trajectory 200 is not taken into account. Then again, as evident from FIG. 4b, this section is relatively short if the elevational change, in particular gradient, 305 of the outward journey trajectory 200 is taken into account. The shortened view 310 of the section 300 with the elevational change, in particular gradient, 305 within the image data 215 can thus be brought about in corresponding fashion when ascertaining the return journey trajectory 210. What this can achieve is that the return journey trajectory 210 (ascertained taking account of the elevational change information) fits to the displayed image data 215. As a consequence, the quality of the driver assistance can be increased.

Thus, measures are described which enable a precise visualization of the traveled path 210 in a parking maneuvering system, in a manner dependent on the topology of the recorded path 200 (in particular during an outward journey 203). The traveled path 210 can be displayed as for example a driving path with or without directional arrow. Further, the traveled path 210 can be shown in one or more different perspectives of the surround of the vehicle 100 (e.g., rearward view, bird's eye perspective, etc.).

As set forth at the outset, the situation may arise that the projected trajectory 210 is not located on the roadway but is situated in the air or in the ground depending on the gradient (or drop) 305 if the topology of the recorded path 200 is not taken into account when projecting the driving path 210 into the camera image 215 from the rearward camera 106.

When recording the path 200 relevant to the trajectory representation 210, it is therefore possible to take account of the third dimension, i.e. the topology, in addition to the vehicle odometry (X-position, Y-position), with the result that the path 210 can be displayed correctly on the roadway visible in the image data 215 when projecting the trajectory 200, even in the case of a gradient and/or drop (i.e. a negative gradient) 305.

Thus, the (positive and/or negative) elevational change, in particular gradient, 305 of the current vehicle position can be ascertained and stored at each waypoint 201, 301, 302, 202, in addition to the position in the X-direction and Y-direction and optionally in addition to the yaw angle, for the purpose of recording a trajectory 200 by a parking maneuvering system. In an alternative or in addition, the positional data in relation to trajectory 200 may be stored on the basis of segments (rather than the xy-position).

The elevational change information may be ascertained from one or more different sources, for example by a sensor 103 and/or on the basis of map information in relation to the roadway traveled by the vehicle 100.

In the case of the perspective projection of the three-dimensional path 200 along the recorded waypoints 201, 301, 302, 202, it is possible (as illustrated by way of example in FIG. 4b) to also take account of the Z-position of the respective waypoint 201, 301, 302, 202 relative to the current vehicle position (i.e. relative to the projection point 401) in addition to the X-position and Y-position of the individual waypoints 201, 301, 302, 202. To this end, the elevational change information is preferably stored in a form allowing the absolute difference in Z-direction to be ascertained between the current vehicle position (i.e. between the current projection point 401) and the waypoint 201, 301, 302, 202 to be projected.

FIG. 5 shows a flowchart of an (optionally computer-implemented) method 500 for providing a driver assistance during a second journey 213 (in particular during a return journey) along a trajectory 200 recorded during a first journey 203 (in particular during an outward journey).

The method 500 comprises the ascertainment 501 of elevational change information, in particular gradient data, in relation to a (positive or negative) elevational change, in particular gradient, 305 of the trajectory 200 recorded during the first journey 203. In the process, the respective height (along the z-axis) can be specified for a multiplicity of waypoints 201, 301, 302, 202 of the recorded trajectory 200. The individual waypoints 201, 301, 302, 202 can be specified as coordinates of the x-axis and/or y-axis. The elevational change information can be ascertained or have been ascertained on the basis of the sensor data from one or more vehicle sensors 103 (e.g., an IMU) and/or on the basis of map data in relation to the roadway traveled by the vehicle 100.

The method 500 also comprises the consideration 502 of the elevational change information for providing a driver assistance (or a driver assistance function) during the second journey 213. In particular, the elevational change information can be used to ascertain a display trajectory 210 which is displayed for the driver on a display unit 105 (of the vehicle 100) so as to assist them during the second journey 213. Taking account of the elevational change information allows the quality of the driver assistance to be efficiently and reliably increased.

The present invention is not limited to the exemplary embodiments shown. In particular, it should be observed that the description and the figures are intended to illustrate the principle of the proposed methods, apparatuses and systems only by way of example.

1.-10. (canceled)

11. A system designed to assist a driver of a motor vehicle during a second journey along a trajectory recorded within a scope of a first journey, comprising:
a driver assistance system operatively configured to:
ascertain elevational change information in relation to an elevational change of the trajectory recorded within the scope of the first journey;
ascertain a display trajectory for the second journey taking into account the elevational change information; and
cause the display trajectory to be displayed on a display of the vehicle.

12. The system according to claim 11, wherein during the second journey, the driver assistance system is configured to:
ascertain image data in relation to a surround of the vehicle located in front of the vehicle in the direction of travel using at least one camera of the vehicle; and
cause, based on the image data, a pictorial representation showing the display trajectory overlaid on the surround of the vehicle to be displayed on the display.

13. The system according to claim 11, wherein during the second journey, the driver assistance system is configured to:
repeatedly ascertain a respective actual position of the vehicle;
repeatedly update the display trajectory in a manner dependent on the respective actual position and dependent on the elevational change information; and
repeatedly cause the respective updated display trajectory to be displayed on the display of the vehicle.

14. The system according to claim 13, wherein the respective actual position of the vehicle is a respective actual position of the camera of the vehicle.

15. The system according to claim 14, wherein the driver assistance system is configured to:
determine a projection point of the camera at the respective actual position of the vehicle; and
project a multiplicity of waypoints on the trajectory recorded during the first journey onto a projection plane in a manner dependent on the projection point and dependent on the elevational change information, in order to determine the display trajectory.

16. The system according to claim 15, wherein the elevational change information indicates an elevation of the multiplicity of waypoints along an elevation axis; and
the driver assistance system is configured to:
project the multiplicity of waypoints onto the projection plane in a manner dependent on the respective elevation, in order to ascertain the display trajectory.

17. The system according to claim 16, wherein
the elevation axis is arranged within the projection plane; and/or
the elevation axis corresponds to a vertical axis of the vehicle when the vehicle is aligned horizontally.

18. The system according to claim 11, wherein the driver assistance system is configured to:
ascertain trajectory data in relation to the trajectory recorded during the first journey, the trajectory data indicating positions of a multiplicity of waypoints on the trajectory recorded during the first journey and the elevational change information indicating a relative elevation of the multiplicity of waypoints relative to one another and/or an elevation difference between the multiplicity of waypoints; and
take into account the trajectory data when providing the driver assistance during the second journey.

19. The system according to claim 11, wherein
the first journey comprises an outward journey from a first point to a second point, and the second journey comprises a corresponding return journey from the second point to the first point; or
the first journey comprises a journey from a first point to a second point, and the second journey comprises another journey from the first point to the second point.

20. The system according to claim 11, wherein the driver assistance system is configured to:
read the elevational change information from a memory unit of the vehicle in order to ascertain the elevational change information; and
wherein the elevational change information was recorded during the first journey and stored in the memory unit.

21. A method for providing a driver assistance during a second journey along a trajectory recorded within a scope of a first journey, the method comprising the steps of:
ascertaining elevational change information in relation to an elevational change of the trajectory recorded within the scope of the first journey;
ascertaining a display trajectory for the second journey taking into account the elevational change information; and
displaying the display trajectory on a display.
